(19) United States
(12) Patent Application Publication
(10) Pub. No.: US 2003/0164174 A1
(43) Pub. Date: Sep. 4, 2003

(54) Method of working a concrete surface

(76) Inventors: Carl Akesson Stromdahl, Enskada (SE); Conny Tangring, Saltsjo-Boo (SE)

Correspondence Address: Mark P Stone, Suite 205, 1100 High Ridge Road, Stamford, CT, 06905, US

(21) Appl. No.: 10/362,119

(22) PCT Filed: Oct. 10, 2001
(86) PCT No.: PCT/SE01/02196

(30) Foreign Application Priority Data
Oct. 13, 2000 (SE) 0003697-0

(51) Int. Cl. B08B 3/02

(52) U.S. Cl. 134/2

(57) ABSTRACT

One cuts away the surface layer of a concrete surface, for example the roadway of a concrete bridge, by using a water jet ejected out of a nozzle 31 on an elongated nozzle holder 30. One reciprocates the nozzle holder in cutting sweeps and moves the entire machine in steps between the cuttin sweeps. The water jet is directed obliquely forwardly in the directions of the sweeps and, at the ends of the sweeps, the nozzle holder is swung to its new angle of attack for the subsequent cutting sweep. When the water jet reaches the end of the cutting in a cutting sweep, the nozzle holder begins to swing backwards at the same time as its linear velocity increases so that its target area will remain unchanged or almost unchanged at the same time as the stepping of the machine starts so that the water jet will make a cut 34 forwardly in the direction of stepping. The stepping and the change of angle of attack are finished simultaneously and a new cutting sweep starts directly. Suitably, the nozzle holder should be oscillated in a plane transverse to the direction of the sweeps so that the cut track will be wider.

### TECHNICAL FIELD OF THE INVENTION

This invention relates to a method of working a concrete surface by a water jet by using a machine that comprises a water jet nozzle at the end of an elongated nozzle holder carried by a trolley that is movable to and fro along a guide. The holder with its nozzle is moved in working sweeps with the nozzle in an attacking angle, and at the end of a sweep, the holder is swung into a position in which the nozzle will have an attacking angle during the subsequent sweep, and the guide with the trolley and the holder is stepped forward between the sweeps.

### BACKGROUND TECHNIQUE

Road salting influences concrete and the surface layer for example on concrete bridges must be renewed after a number of years before the road salt has reached the reinforcement. The maintenance costs will be high if the salt already has had an effect on the reinforcement. Therefore, one wants to remove the surface layer and free the uppermost layer of reinforcement before the reinforcement has been influenced and then replace it with a new surface layer. Machines for such concrete removal are known from SE-451742-B, U.S. Pat. No. 5,361,993-A and SE 508821-C.

U.S. Pat. No. 5,361,993-A shows and describes a machine that is to be used in the way described above. The elongated nozzle holder is carried by a trolley that rolls on a guide. When the trolley reaches its end position, it remains there and the entire machine is stepped forwards so that the guide for the trolley is moved forwards. The trolley is still not moving while the nozzle holder is swung in order to provide an attack angle for the subsequent sweep. When the holder with its nozzle has reached its predefined angle, the trolley begins its movement. The nozzle moves with the same speed during its swinging movement as during the movement of the trolley.

### OBJECT OF INVENTION AND BRIEF DESCRIPTION OF AN EXAMPLE OF THE INVENTION

It is an object of the invention to provide a more uniform cutting at the edges than can be reached by prior art technique. To this end, when the water jet reaches its end position, the holder is swung to give the nozzle its attacking angle in the subsequent step while the carrier continues its movement towards its position of turning. The invention has been given the characteristics defined in the claims.

It is advantageous to step forward the holder (30) while it is being swung to its new attacking angle. It is then also advantageous to adapt the swing velocity of the holder to its linear movement so that the water jet makes a cut (34) in the direction of stepping. It is particularly advantageous to begin and end the stepping and the swinging of the holder simultaneously.

### THE FIGURES AND A DETAILED DESCRIPTION OF AN EXAMPLE OF THE INVENTION

FIG. 1 is a side view of a machine by which the method according to the invention can be carried out.

FIG. 2 is a top elevation view of the machine.

FIGS. 4,6 and 8 show schematically and in section a concrete roadway, the surface of which is cut by the machine shown in FIG. 1, only a few parts of the machine being shown.

FIGS. 5,7 and 9 show the respective pattern of movement of a water nozzle shown in FIGS. 4,6 and 8.

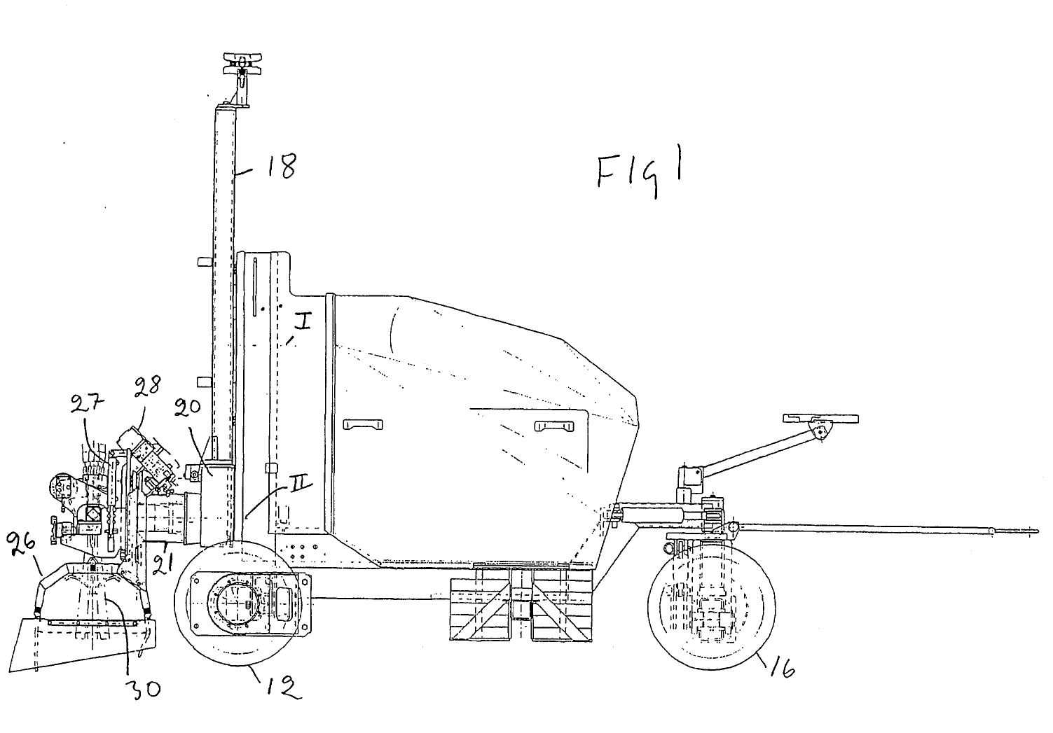

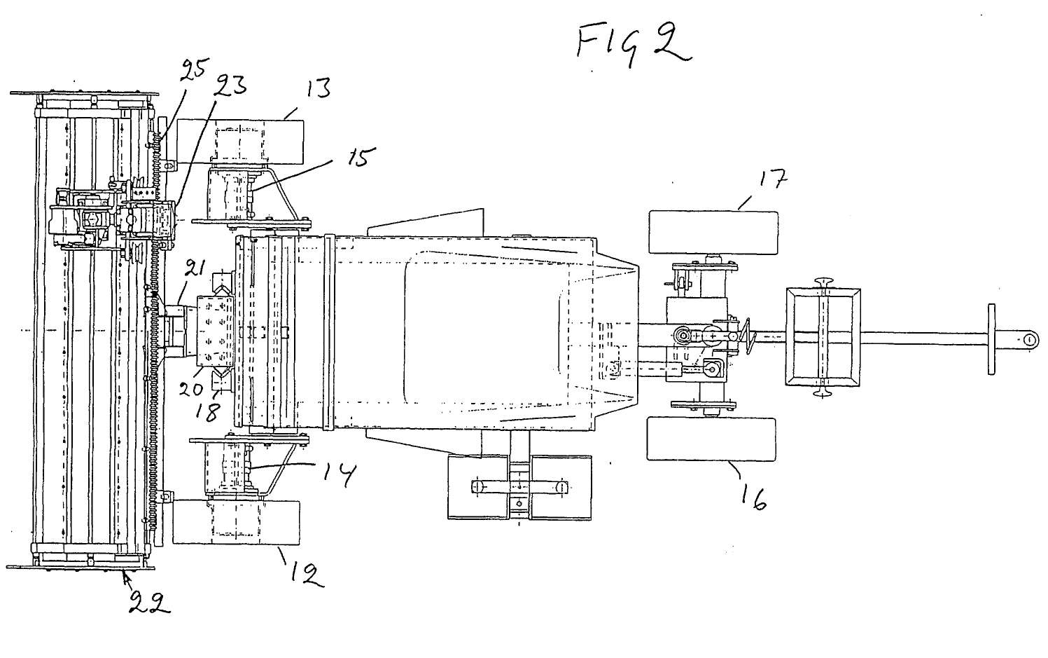

The machine shown in the FIGS. 1-3 has two front wheels 12,13 with built-in motors 14,15 and it is steerable by its rear wheels 16,17. The machine has a pillar 18 that is rotatable about an axis I and makes a guide for a carrier 20. The carrier 20 carries a mount 21 for a feed beam or guide 22 that is at right angle to an axis II about which the feed beam can be rotated. This arrangement provides a great freedom in the positioning of the feed beam.

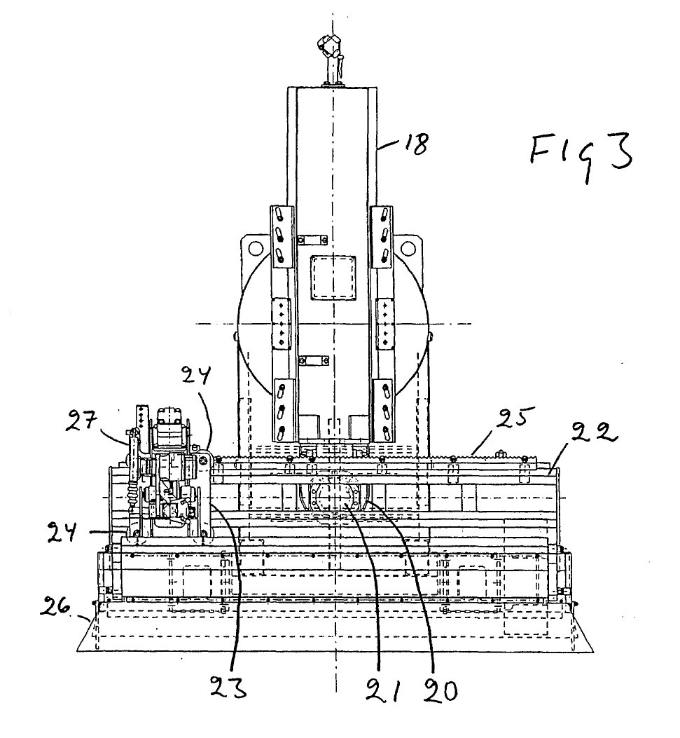

The feed beam 22 carries a trolley 23 with four wheels 24, and the trolley 23 has a built-in motor with pinions meshing with a rack 25 on the feed beam. The trolley 23 carries a holder 30 for a water jet nozzle 31 inside a protective shield 26. The holder 30 is swingable in the plane of the paper in FIG. 3 by means of a hydraulic cylinder 27 in order to provide for a suitable attacking angle of the nozzle both when the carrier moves to the right and to the left in FIG. 3 as will be described with reference to the FIGS. 4-9. In addition, a motor 28 is arranged to oscillate the holder 30 in the plane of the paper in FIG. 1, and the central position of the holder as well as its end positions are indicated in FIG. 1.

FIG. 4 shows a concrete track, for example a roadway 35 on a bridge, the surface of which is being cut by means of the machine shown in FIGS. 1-3. Only the trolley 23 with its wheels and the elongated nozzle holder 30 with its nozzle 31 are shown in the figure. The holder is swingable about an axis III. The roadway is shown in section in FIGS. 4,6 and 8 while being worked.

A preferred cycle of working will now be described with reference to the FIGS. 4-9.

The trolley 23 is shown in FIG. 4 in its movement to the right in the figure as indicated by the arrow. During that working sweep, the nozzle holder has had an attacking angle as shown in the figure and the water jet out of the nozzle 31 has cut away the surface layer of the concrete so that the uppermost layer of reinforcement 36 has been freed. When the trolley reaches its position shown, the nozzle holder begins-to swing over to its attacking angle it will have during the subsequent working sweep to the left in the figure. At the same time, the trolley increases its speed to the right in the figure so that the nozzle will remain in about the same position as shown in FIG. 6 until the nozzle holder 30 reaches its new angle of attack. During this movement, the whole machine is stepped forward (out of the paper) by means of the motors 14,15 of the front wheels 12,13 and the water jet will then make a cut 34 forwards as shown in FIG. 6.

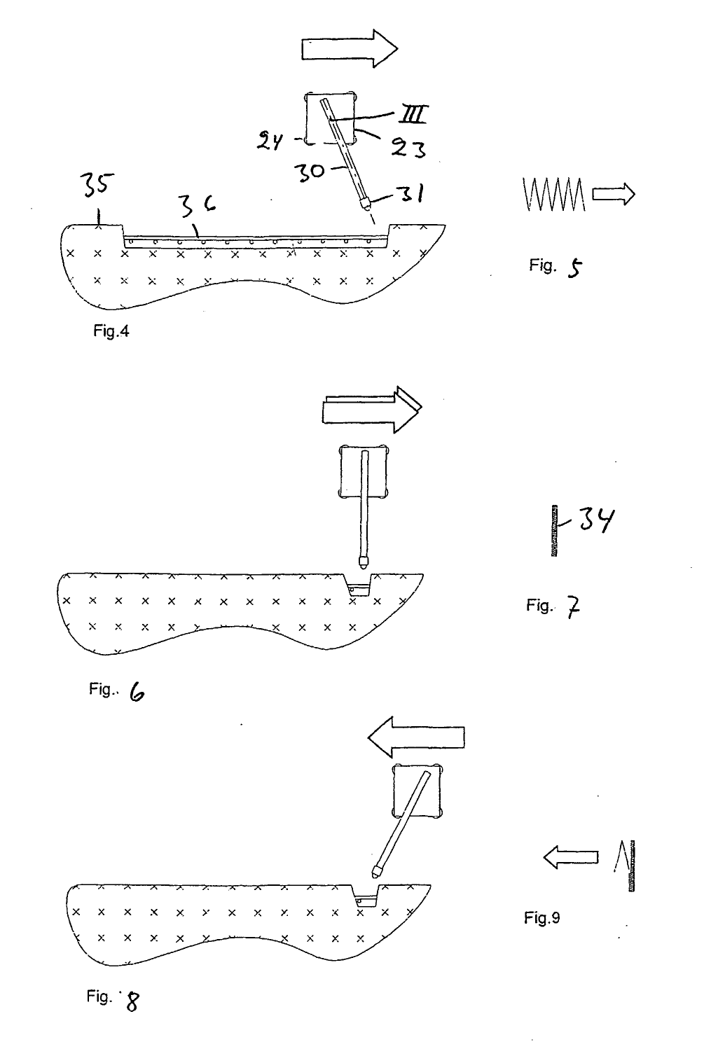

Since the nozzle holder all the time is oscillated transverse to the movement of the trolley 23 in a frequency that is high as compared to the movement of the trolley, the target area of the water jet will have the path shown in FIG. 5. Suitably, in practice, the oscillation is faster in relation to the speed of the trolley 23 than shown in FIG. 5. The trolley can for example move in a velocity of 5-10 m/s during the sweep shown in figure 4 and for example in doubled velocity during the final phase shown in FIG. 6 whereas the oscillation frequency can for example be 40-400 double strokes per minute. The oscillation makes the cut track wide although the water jet is narrow.

FIG. 7 shows the target track of the water jet until the new angle of attack is reached. Then, the trolley 23 turns and begins its cutting sweep to the left in FIG. 8. FIG. 9 shows the track of the target area of the water jet until the cutting to the left in the figure has begun in the cutting sweep to the left. The turning at the end of this cutting sweep to the left is carried out in the same way as the described turning at the end of a cutting sweep to the right. The water jet can be continuous during the entire process.

By adapting to each other the velocity of the trolley 23 and the swing velocity of the nozzle holder 30 during the change of attack angle, one can get a cutting at the end of the cutting sweeps that corresponds to the cutting during the major part of the cutting sweeps. Otherwise, there can be bumps and pits near the sides of the cutting area. It is also advantageous to make the steps during the change of angle of attack as described. One can easily make changes in any one of the parameters during the cutting until the best result is reached. Suitably, the stepping and the change of angle of attack should start and finish simultaneously. A suitable angle of attack can be freely chosen without affecting the cutting close to the sides of the cutting area.

1. A method of working a concrete surface (35) by a water jet—by using a machine that comprises a water jet nozzle (31) at the end of an elongated nozzle holder (30) carried by a trolley (23) that is movable to and fro along a guide—wherein the holder with the nozzle is moved in working sweeps with the nozzle in an attacking angle, and at the end of a sweep, the holder is swung into a position in which the nozzle will have an attacking angle during the subsequent sweep, and the guide with the trolley and the holder is stepped forward between the sweeps,
characterised in that
when the water jet reaches its end position, the holder (30) is swung to give the nozzle (31) its attacking angle in the subsequent step while the trolley (23) continues its movement towards its position of turning.

2. A method according to claim 1, characterised in that the holder (30) is stepped forward while being swung towards its new attacking angle.

3. A method according to claim 2, characterised in that the swing velocity of the holder (30) and the linear movement of the trolley (23) are adapted to each another so that the water jet makes a cut (34) in the direction of stepping.

4. A method according to claim 3, characterised in that the stepping and the swinging of the holder end simultaneously

5. A method according to any one of the preceding claims, characterised in that the velocity of the trolley (23) is increased when the water jet reaches its end position and maintained increased until the holder (30) has reached its new attacking angle.
